(19) United States
(12) Patent Application Publication
(10) Pub. No.: US 2026/0280874 A1
(43) Pub. Date: Sep. 17, 2026

(54) RANDOM GENERATOR OF ORTHOGONAL MATRICES IN FINITE FIELDS

(71) Applicant: NEW YORK UNIVERSITY IN ABU DHABI CORPORATION, Abu Dhabi (AE)

(72) Inventors: Lasha EPHREMIDZE, T'bilisi (GE); Ilya SPITKOVSKY, Las Vegas, NV (US)

(73) Assignee: NEW YORK UNIVERSITY IN ABU DHABI CORPORATION, Abu Dhabi (AE)

(21) Appl. No.: 19/469,276

(22) PCT Filed: Mar. 29, 2024
(86) PCT No.: PCT/IB2024/053068

§ 371 Date: Sep. 25, 2025

Related U.S. Application Data
(60) Provisional application No. 63/455,534, filed on Mar. 29, 2023.

(51) Int. Cl. H04L 9/30; G06F 17/16; H04L 9/06

(52) U.S. Cl. CPC H04L 9/3026; G06F 17/16; H04L 9/0637

(57) ABSTRACT

Systems and methods for generating n×n orthogonal matrices in the Galois field GF(q) that is highly efficient and can handle large values of n and q. This method is based on random selection. In addition, this method can be used to construct paraunitary filter banks over finite fields, in applications such as signal processing. This approach can be useful constructing orthogonal matrices that satisfy specific constraints, making it potentially valuable for applications in coding theory and encryption.

### CROSS-REFERENCE TO RELATED APPLICATIONS

This application claims the benefit of and priority to U.S. Provisional Patent App. No. 63/455,534, filed Mar. 29, 2023, the contents of which are incorporated herein by reference.

### TECHNICAL FIELD

The present disclosure relates generally to a random generator of orthogonal matrices in finite fields.

### BACKGROUND

Spectral factorization is a powerful mathematical tool with various applications in control engineering and communications. The Janashia-Lagvilava method has been developed over the years to solve the challenging spectral factorization problem in the matrix case. This method has been successfully algorithmized and offers several advantages over existing methods, as demonstrated in previous works. One noteworthy advantage of this method, which can be achieved through a suitable modification, is that it unexpectedly has the ability to generate a multitude of orthogonal matrices over finite fields in mere milliseconds, potentially finding applications in coding theory.

The Janashia-Lagvilava method has been discovered to be closely related with wavelet theory. Furthermore, the method has been recently generalized for any field satisfying the minimal requirements. However, these requirements necessitate the existence of a positive element in the field, precluding finite fields. In fact, the field of rational polynomials in several complex variables was the main focus of related paper Ephremidze & Epitkovsky, “On the generalization of the Janashia-Lagvilava method for arbitrary fields,” Georgian Mathematical Journal 29(3), pp. 353-362 (2022) (hereinafter “Generalization”), and by taking this viewpoint, it was possible to generalize the Janashia-Lagvilava method to matrix functions on the multidimensional torus. The main result of Generalization, Theorem 4.1, does not hold for finite fields and, accordingly, the procedure described therein cannot guarantee the construction of the required unitary matrix polynomial for finite fields. Nevertheless, as it was further realized and confirmed by numerical simulations, the isolated cases of failure do not exclude the existence of statistically robust method of constructing above mentioned unitary matrix polynomials for finite fields, while these matrix polynomials can be converted into orthogonal matrices.

Described herein is a superfast method for constructing orthogonal matrices M∈ [symbol] (n, q) in finite fields GF(q). It can be used to construct n×n orthogonal matrices in Zₚ with very high values of n and p, and also orthogonal matrices with a certain circulant structure. Equally well one can construct paraunitary filter banks or wavelet matrices over finite fields. The construction mechanism is highly efficient, allowing for the complete screening and selection of an orthogonal matrix that meets specific constraints. For instance, one can generate a complete list of orthogonal matrices with given n and q=p^{m} provided that the order of [symbol] (n, q) is not too large, based on the limits of the computer system. Although the method is based on randomness, isolated cases of failure can be identified well in advance of the basic procedure's start. The proposed procedures are based on the Janashia-Lagvilava method which was developed for an entirely different task, therefore, it may seem somewhat unexpected.

### SUMMARY

One embodiment relates to constructing an orthogonal matrix from finite fields. In particular, a random orthogonal matrix is constructed. The orthogonal matrix maybe utilized to encode information. A discrete wavelet matrix or paraunitary matrix may be constructed from the orthogonal matrix and utilized for signal processing.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore not to be considered limiting of its scope, the disclosure will be described with additional specificity and detail through use of the accompanying drawings.

FIG. 1 shows a rate of construction of orthogonal matrices.

FIG. 2 shows a rate of construction of orthogonal matrices utilizing permutations.

FIG. 3 illustrates a computer system for use with certain implementations.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Described herein are systems and methods for a random generator of orthogonal matrices in finite fields. It should be appreciated that orthogonal matrices, in particular random generators of such matrices have applications in a wide range of fields. Embodiments utilizing the approaches described in further detail below may include encrypting by use of the generated orthogonal matrix. Further, such encryption may be used for cryptography, including for encrypted communications as well as for cryptocurrency or related functions. Extending beyond cryptography, such orthogonal matrices maybe harnessed as part of a signal processing function and device.

This application incorporates by reference U.S. patent application Ser. No. 16/557,944, filed Aug. 30, 2019, now U.S. Pat. No. 10,951,919, and U.S. patent application Ser. No. 16/557,887, filed Aug. 30, 2019, now abandoned, which claims priority to U.S. Provisional Patent App No. 62/725,700, filed Aug. 31, 2018, and U.S. Provisional Patent App. No. 62/726,868, filed Sep. 4, 2018. This application also incorporates by reference U.S. patent application Ser. No. 12/989,736, filed May 1, 2009, now U.S. Pat. No. 9,318,232.

Specifically, described herein are efficient computational procedures for proving the following theorem.

Theorem 1. Let [symbol] be a finite field and G be an n×n matrix function of the form:

$$G ( t ) = ( \begin{matrix}1 & 0 & 0 & … & 0 & 0 \\ 0 & 1 & 0 & … & 0 & 0 \\ 0 & 0 & 1 & … & 0 & 0 \\ ⋮ & ⋮ & ⋮ & ⋮ & ⋮ & ⋮ \\ 0 & 0 & 0 & … & 1 & 0 \\ {ζ}_{1} ( t ) & {ζ}_{2} ( t ) & {ζ}_{3} ( t ) & … & {ζ}_{n - 1} ( t ) & 1\end{matrix} ) \qquad ( 1 )$$

where

$${ζ}_{i} ( t ) = {\sum }_{k = 1}^{N} {γ}_{i k} {t}^{- k} ,$$

i=1, 2, . . . , n−1 are Laurent polynomials, 0, 1, Yᵢₖ∈ [symbol] . Denote by Γᵢ, i=1, 2, . . . , n−1, the Hankel matrices:

$${Γ}_{i} = ( \begin{matrix}0 & {γ}_{i 1} & {γ}_{i 2} & … & {γ}_{i , N - 1} & {γ}_{i N} \\ {γ}_{i 1} & {γ}_{i 2} & {γ}_{i 3} & … & {γ}_{i N} & 0 \\ {γ}_{i 2} & {γ}_{i 3} & {γ}_{i 4} & … & 0 & 0 \\ \cdot & \cdot & \cdot & … & \cdot & \cdot \\ {γ}_{i 1} & 0 & 0 & … & 0 & 0\end{matrix} ) \qquad ( 2 )$$

and by Δ the following (N+1)×(N+1) matrix:

$$Δ = {\sum }_{i = 1}^{n - 1} {Γ}_{i}^{2} + {I}_{N + 1}$$

If det Δ≠0, then there exists a unique n×n polynomial matrix U:

$$U ( t ) = ( \begin{matrix}{u}_{11} ( t ) & {u}_{12} ( t ) & … & {u}_{1 , n - 1} ( t ) & {u}_{1 n} ( t ) \\ {u}_{21} ( t ) & {u}_{22} ( t ) & … & {u}_{2 , n - 1} ( t ) & {u}_{2 n} ( t ) \\ ⋮ & ⋮ & ⋮ & ⋮ & ⋮ \\ {u}_{n 1} ( t ) & {u}_{n 2} ( t ) & … & {u}_{n , n - 1} ( t ) & {u}_{nn} ( t )\end{matrix} ) \qquad ( 3 )$$

$${u}_{i j} ( t ) = {\sum }_{k = 0}^{N} {a}_{ij , k} {t}^{k} ,$$

a_{ij,k}∈ [symbol] such that the entries in the product matrix:

$$G ( t ) diag ( 1 , 1 , … , 1 , {t}^{- N} ) U ( t )$$

contain only the non-negative powers of t (i.e., the coefficients of t^{-k}, k=1, 2, . . . , are 0 of [symbol] ) and, in addition, U(1)=Iₙ.

Furthermore, the matrix polynomial in Eq. (3) has the property that:

$$U ( t ) \tilde{U} ( t ) = {I}_{n} \qquad ( 4 )$$

$$where \tilde{U} ( t ) = {\sum }_{k = 0}^{N} {U}_{k}^{T} {t}^{- k} for U ( t ) = {\sum }_{k = 0}^{N} {U}_{k} {t}^{k} .$$

The straightforward computations show that, due to the property Eq. (4), the n×n matrix:

$${W}_{0} = U ( - 1 ) = {U}_{0} - {U}_{1} + {U}_{2} - … {( - 1 )}^{N} {U}_{N}$$

and the block circulant n(N+1)×n(N+1) matrix W with the first (block) row:

$${W}_{1} = ( {U}_{0} {U}_{1} … {U}_{N} ) \qquad ( 5 )$$

are orthogonal, i.e.:

$${W}_{0} {W}_{0}^{T} = {I}_{n} and {WW}^{T} = {I}_{n ( N + 1 )} \qquad ( 6 )$$

Hence, relying on the proof of Theorem 1, after selecting positive integers n and N, one can randomly generate the coefficients Yᵢₖ, 1≤i<n, 1≤k≤N, of polynomials ζi in Eq. (1) from the field [symbol] and construct the orthogonal matrices satisfying Eq. (6). Concerning computer memory allocation, these (n−1)N integers, γᵢₖ (generators), contain full (lossless) information about n²(N+1) integers of W₁ in Eq. (5). Explicit formulas converting the matrix W₁ back into the generators are also provided.

Note that the method generates only the trivial matrix W₀=Iₙ for q=2 since −1=1 in GF(2) and U(1)=Iₙ by construction. However, the circulant matrix W still may be different from the trivial matrix I_{n(N+1)}.

The Janashia-Lagvilava method in fact contains the proof of the above theorem. However, the primary theoretical improvement of the Janashia-Lagvilava method proposed in what follows is the modification of the existing computational procedures. This modification eliminates the need to invert any n×n matrix, which was previously required, and makes the entire procedure superfast. Namely, constructing orthogonal matrices W₀ and W of sizes n×n and n(N+1)×n(N+1), respectively, requires O(N³)+(N+1)²n² (with the exact constant 1 instead of [symbol] in front of the second summand) multiplications (in the field [symbol] ). Furthermore, for arbitrarily large n, it is possible to select the second parameter N as small as 1, admitting a moderate level of randomness.

### Notation.

This section summarizes the notation used throughout the application. Let [symbol] =GF(q)=GF(p^{m}) be the Galois field consisting of q=p^{m} elements, where p is a prime number and [symbol] ≅Z (mod p). Wherever if one encounters 0 or 1, they are presumed to belong to this field, while −1 is the additive inverse of 1 in [symbol] .

For a set [symbol] , let [symbol] ^{n×k} be the set of n×k matrices with entries from [symbol] , while [symbol] ⁿ: = [symbol] ^{n×1}. Iₙ=diag(1,1, . . . , 1)∈ [symbol] ^{n×n} is the identity matrix, and 0_{n×k}∈ [symbol] ^{n×k} is the n×k matrix consisting of zeros. A matrix M∈ [symbol] ^{n×k} with entries Mᵢⱼ∈ [symbol] is denoted by

$$M := {[ {M}_{i j} ]}_{i = 1 : n}^{j = 1 : k} ,$$

or simply by M:=[Mᵢⱼ]. A matrix M=[Mᵢⱼ]∈ [symbol] ^{n×n} is called orthogonal if:

$${MM}^{T} = {I}_{n} \qquad ( 7 )$$

where M^{T}=[Mᵢⱼ] stands for the transpose of M. The above equation implies also that M^{T}M=Iₙ. The set of orthogonal n×n matrices in GF(q) is denoted by [symbol] (n, q).

Let [symbol] = [symbol] [ [symbol] ] be the set of Laurent polynomials with coefficients from [symbol] :

$$𝒫 := \{ {\sum }_{k = {k}_{1}}^{{k}_{2}} {c}_{k} {t}^{k} \text{:} {c}_{k} ∈ 𝔽 , {k}_{1} , {k}_{2} ∈ ℤ ; {k}_{1} \leq {k}_{2} \} \qquad ( 8 )$$

Further, one can also consider the following subsets of [symbol] : [symbol] ⁺, [symbol] ⁻,

$$, {𝒫}_{N}^{+} ,$$

and

$${𝒫}_{N}^{-} ,$$

where N is a non-negative integer, which corresponds to sets k₁=0, k₂=0, 0=k₁≤k₂=N, and −N=k₁≤k₂=0 in Eq. (8), respectively. So, [symbol] ⁺ is the set of usual polynomials, and

$${𝒫}_{N}^{+}$$

is the set of polynomials of degree less than or equal to N. Of course, any polynomial P∈ [symbol] [ [symbol] ],

$$P ( t ) = {\sum }_{k = {k}_{1}}^{{k}_{2}} {c}_{k} {t}^{k} \qquad ( 9 )$$

can be considered as the function P: [symbol] → [symbol] by plugging in it the values from [symbol] instead of indeterminate variable t. The coefficient c₀∈ [symbol] is called the free term of P. It is also naturally assumed that [symbol] ⊂ [symbol] [ [symbol] ], i.e., c∈ [symbol] can be identified with the (constant) polynomial ct⁰. Saying that a polynomial Eq. (9) is constant means that all coefficients, except for a possible term c₀, are zero. In this case, this can be represented in shorthand as P(t)=c₀. In a similar manner, P∈ [symbol] ⁺ means that all the coefficients of P corresponding to negative powers of t are equal to 0.

A matrix (Laurent) polynomial P∈ [symbol] ^{n×k} can also be viewed as a polynomial with matrix coefficients,

$$P ( t ) = {\sum }_{k = {k}_{1}}^{{k}_{2}} {C}_{k} {t}^{k} , {C}_{k} ∈ {𝔽}^{n \times k} \qquad ( 10 )$$

For a polynomial Eq. (9), let

$$\tilde{P} ( t ) = {\sum }_{k = {k}_{1}}^{{k}_{2}} {c}_{k} {t}^{- k} \qquad ( 11 )$$

and for a matrix polynomial Eq. (10), let

$$\tilde{P} ( t ) = {\sum }_{k = {k}_{1}}^{{k}_{2}} {C}_{k}^{T} {t}^{- k} \qquad ( 12 )$$

i.e., if

$$P ( t ) = {[ {P}_{ij} ( t ) ]}_{i = 1 : n}^{j = 1 : k} ,$$

then

$$\tilde{P} ( t ) = {[ {\tilde{P}}_{ji} ( t ) ]}_{j = 1 : k}^{i = 1 : n} .$$

A matrix polynomial A is called paraunitary if

$$A ( t ) \tilde{A} ( t ) = {I}_{n} \qquad ( 13 )$$

i.e., all matrix coefficients of A Ã are 0_{n×n} except the free term, and the latter is equal to Iₙ. Thus, the matrix polynomial U in Eq. (4) is para-unitary.

The symbol δᵢⱼ stands for the Kronecker delta, i.e., δᵢⱼ=1 if i=j and δᵢⱼ=0 otherwise.

Note that basic linear algebra rules apply to linear spaces over finite fields, and therefore they can be used without further justification.

### Constructive Proof of Theorem 1.

The methods described herein mainly follow the path developed in the Janashia-Lagvilava method. Therefore, many details given therein are not repeated, and only the arising differences are emphasized.

Construction of the para-unitary matrix Eq. (3), for a given matrix Eq. (1), starts by considering the following system:

$$\{ \begin{matrix}{ζ}_{1} {x}_{n} - \tilde{{x}_{1}} ∈ {𝒫}^{+} , \\ {ζ}_{2} {x}_{n} - \tilde{{x}_{2}} ∈ {𝒫}^{+} , \\ ⋮ \\ {ζ}_{n - 1} {x}_{n} - \tilde{{x}_{n - 1}} ∈ {𝒫}^{+} , \\ {ζ}_{1} {x}_{1} + {ζ}_{2} {x}_{2} + … + {ζ}_{n - 1} {x}_{n - 1} + \tilde{{x}_{n}} ∈ {𝒫}^{+} .\end{matrix} \qquad ( 14 )$$

The solution is sought in the class

$${𝒫}_{N}^{+} ,$$

i.e., for (x₁, x₂, . . . , xₙ)

$$∈ {( {𝒫}_{N}^{+} )}^{1 \times n}$$

satisfying the conditions of the system Eq. (14).

It is proved in prior publications that if n different solutions are found:

$${U}_{j} ( t ) = {( {x}_{1}^{j} ( t ) , {x}_{2}^{j} ( t ) , … , {x}_{n}^{j} ( t ) )}^{T} ∈ {( {𝒫}_{N}^{+} )}^{n \times 1} , j = 1 , 2 , … , n \qquad ( 15 )$$

of Eq. (14) satisfying also

$${U}_{j} ( 1 ) = {( {δ}_{1 j} , {δ}_{2 j} , … , {δ}_{nj} )}^{T} \qquad ( 16 )$$

and assume

$${\hat{U}}_{j} ( t ) = {( {x}_{1}^{j} ( t ) , {x}_{2}^{j} ( t ) , … , {x}_{n - 1}^{j} ( t ) , {t}^{N} \tilde{{x}_{n}^{j} ( t )} )}^{T} , j = 1 , 2 , … , n$$

(the order of coefficients has been reversed in the last entry of Uⱼ in order to get Ûⱼ), then Eq. (3) can be represented as a concatenation of the columns

$$U = ( {\hat{U}}_{1} , {\hat{U}}_{2} , … {\hat{U}}_{n} ) \qquad ( 17 )$$

and thus constructed matrix Eq. (17) will satisfy the condition Eq. (4) as well.

To solve the system Eq. (14), it is rewritten in the equivalent form in terms of the coefficients of polynomial entries. In particular, to obtain the solution Eq. (15) satisfying Eq. (16), Eq. (14) is reduced to

$$\{ \begin{matrix}D \cdot {X}_{1} - {Γ}_{1} \cdot {X}_{n} = 0 , \\ D \cdot {X}_{2} - {Γ}_{2} \cdot {X}_{n} = 0 , \\ … \\ D \cdot {X}_{i} - {Γ}_{i} \cdot {X}_{n} = 1 , \\ … \\ D \cdot {X}_{n - 1} - {Γ}_{n - 1} \cdot {X}_{n} = 0 , \\ {Γ}_{1} \cdot {X}_{1} + {Γ}_{2} \cdot {X}_{2} + … + {Γ}_{n - 1} \cdot {X}_{n - 1} + D \cdot {X}_{n} = 0.\end{matrix} \qquad ( 18 )$$

j=1, 2, . . . , n, where

$$D = ( \begin{matrix}1 & 1 & 1 & … & 1 & 1 \\ 0 & 1 & 0 & … & 0 & 0 \\ 0 & 0 & 1 & … & 0 & 0 \\ \cdot & \cdot & \cdot & … & \cdot & \cdot \\ 0 & 0 & 0 & … & 0 & 1\end{matrix} ) , {Γ}_{i} = ( \begin{matrix}0 & 0 & 0 & … & 0 & 0 \\ {γ}_{i 1} & {γ}_{i 2} & {γ}_{i 3} & … & {γ}_{iN} & 0 \\ {γ}_{i 2} & {γ}_{i 3} & {γ}_{i 4} & … & 0 & 0 \\ \cdot & \cdot & \cdot & … & \cdot & \cdot \\ {γ}_{iN} & 0 & 0 & … & 0 & 0\end{matrix} )$$

0=0_{(N+1)×1}=(0, 0, . . . , 0)^{T}, 1=(1, 0, 0, . . . , 0)^{T}∈ [symbol] are given coefficients, and

$$\begin{matrix}{X}_{i} = {( {a}_{i 0} , {a}_{i 1} , … {a}_{iN} )}^{T} , where \\ {x}_{i} ( t ) = {\sum }_{k = 0}^{N} {a}_{ik} {t}^{k}\end{matrix}$$

are unknown matrix coefficients. Note that matrices D and Γᵢ differ from the corresponding matrices in the first row. This replacement is justified by freedom of selection of constant terms of polynomials entering Eq. (14). On the other hand, this exibility allows the condition U(1)=Iₙ to be merged into the system Eq. (14). Therefore, one can avoid an expensive step of inverting n×n matrix required in preceding papers. Note also that Γᵢ differs from Eq. (2) in the same way, however, this difference is immaterial and the notation is retained for convenience.

The system in Eq. (18) is solved in a natural way, having:

$${X}_{i} = {D}^{- 1} \cdot {Γ}_{i} \cdot {X}_{n} + {δ}_{ij} {D}^{- 1} \cdot 1 , i = 1 , 2 , … , n - 1 \qquad ( 19 )$$

Substituting these equations into the last equation of Eq. (18), the result is

$${Γ}_{1} {D}^{- 1} {Γ}_{1} {X}_{n} + {Γ}_{2} {D}^{- 1} {Γ}_{2} {X}_{n} + … + {Γ}_{n - 1} {D}^{- 1} {Γ}_{n - 1} {X}_{n} + {DX}_{n} = - {Γ}_{j} {D}^{- 1} 1$$

(where it is assumed that the right-hand side is equal to 1 for j=n), which leads to

$$Δ {X}_{n} = - {D}^{- 1} {Γ}_{j} {D}^{- 1} 1 \qquad ( 20 )$$

$$where$$

$$Δ = {\sum }_{i = 1}^{n - 1} {( {D}^{- 1} {Γ}_{i} )}^{2} + {I}_{N + 1}$$

The sufficient condition, det Δ≠0, for the existence of the solution to Eq. (20) is reflected (in the slightly different but equivalent form) in the hypothesis of the theorem. Therefore, assuming that this condition holds, then determine Xₙ from Eq. (20) and then Xᵢ, i=1, 2, . . . , n−1 from Eq. (19).
Paraunitary Filter Banks and Wavelets Over [symbol] .

The theory of paraunitary filter banks (“PFB”) in real and complex fields was developed in Vaidyanathan, “MULTIRATE SYSTEMS AND FILTER BANKS,” Prentice Hall, New Jersey (1993) and is closely related with the concept of wavelet matrices as it is presented in Resnikoff & Wells, “WAVELET ANALYSIS: THE SCALABLE STRUCTURE OF INFORMATION,” Springer, New York (1998). This theory has many applications in signal processing. A complete parameterization of such filter banks and wavelet matrices depending on Janashia-Lagvilava method was proposed in related paper Ephremidze & Lagvilava, “On Compact Wavelet Matrices of Rank m and of Order and Degree N,” Journal of Fourier Analysis and Applications 20, pp. 401-420 (2014) (hereinafter “Compact”)

In Phoong & Vaidyanathan, “Paraunitary filter banks over finite fields,” IEEE Transactions on Signal Processing 45(6), pp. 1443-1457 (1997), PFB were considered over finite fields. It was emphasized that filter banks over finite fields have the advantage that all the round-off error and the coefficient quantization error can be eliminated completely. In addition, its potential applicability in cryptography, in the theory of error-correcting codes, was mentioned. Accordingly, various theoretical properties of PFB were explored. In parallel, the theory of wavelet transforms over finite fields has been proposed by several authors and further applications envisioned. As one can observe, these two developments mostly differ from each other by terminology only.

As paraunitary filter banks are coefficients of polynomial matrices in Eq. (3) with property in Eq. (4), the instant disclosure offers a superfast method for constructing PFB and related wavelet matrices. Furthermore, a great deal of facts observed in Compact and Generalization can be directly extended to finite fields setting as well. In particular, whenever paraunitary matrix

$$U ( t ) = {\sum }_{k = 0}^{N} {U}_{k} {t}^{k} \qquad ( 21 )$$

is constructible by the method described, it is unique for a given set of generators, its determinant is always equal to t^{N}, i.e.,

$$det U ( t ) = {t}^{N} \qquad ( 22 )$$

and the last row of the matrix UN in Eq. (21) cannot be all zeros. Conversely, if one has a paraunitary matrix Eq. (21) such that (n, j)-th entry of UN differs from zero, (U_{N})ₙⱼ≠0, then the generators ζᵢ, i=1, 2, . . . , n−1, can be reconstructed by the formulas

$${ζ}_{i} ( t ) = {[ \tilde{{u}_{ι J}} ( t ) {( {t}^{N} \tilde{{u}_{nJ}} ( t ) )}^{- 1} ]}^{-} , i = 1 , 2 , … , n - 1 \qquad ( 23 )$$

where under

$${( {t}^{N} \tilde{{u}_{nJ}} ( t ) )}^{- 1}$$

it is assumed a formal inverse series of the polynomial

$${t}^{N} \tilde{{u}_{nJ}} ( t )$$

(it exists since its constant term differs from 0), and

$${[ {\sum }_{k = - N}^{∞} {a}_{k} {t}^{k} ]}^{-} := {\sum }_{k = - N}^{- 1} {a}_{k} {t}^{k} .$$

### Numerical Simulations.

Numerical simulations were preformed as described in this section using a MATLAB code that was executed on a laptop equipped with an Intel (R) Core™ i7 8650U CPU (with a clock speed of 1.90 GHz) and 16.00 GB of RAM. Whenever the matrix parameters exceeded the available memory of our local computer, the resting utilized a compute node from the High Performance Computing resources at New York University, Abu Dhabi. The compute node had an Intel® Xeon® CPU E5-2680 v4 @ 2.40 GHz processor, 28 CPUs, and 102 Gigabytes of usable memory. The results of these simulations are given in Tables 1 and 2, respectively.

TABLE 1
Simulation results for orthogonal matrix generation on local laptop.

| n | N | p | t | f | p | t | f | p | t | f | d | t | f |
|---|---|---|---|---|---|---|---|---|---|---|---|---|---|
| 100 | 1 | 7 | 0.04 | 141 | 97 | 0.04 | 14 | 997 | 0.07 | 1 | 4999 | 0.81 | 0 |
| 100 | 10 | 7 | 0.06 | 132 | 97 | 0.06 | 7 | 997 | 0.23 | 1 | 4999 | 4.59 | 0 |
| 100 | 50 | 7 | 0.23 | 144 | 97 | 0.28 | 17 | 997 | 1.14 | 0 | 4999 | 17.1 | 0 |
| 500 | 1 | 7 | 0.07 | 129 | 97 | 0.07 | 12 | 997 | 0.10 | 1 | 4999 | 0.87 | 1 |
| 500 | 10 | 7 | 0.15 | 145 | 97 | 0.18 | 10 | 997 | 0.37 | 2 | 4999 | 4.72 | 0 |
| 500 | 50 | 7 | 0.83 | 155 | 97 | 0.98 | 12 | 997 | 1.92 | 3 | 4999 | 19.2 | 0 |
| 1000 | 1 | 7 | 0.14 | 142 | 97 | 0.15 | 14 | 997 | 0.18 | 0 | 4999 | 0.97 | 0 |
| 1000 | 10 | 7 | 0.42 | 159 | 97 | 0.48 | 11 | 997 | 0.73 | 0 | 4999 | 5.05 | 0 |
| 1000 | 50 | 7 | 2.85 | 151 | 97 | 3.28 | 12 | 997 | 4.46 | 1 | 4999 | 25.4 | 0 |
| 5000 | 1 | 7 | 2.24 | — | 97 | 2.31 | — | 997 | 2.72 | — | 4999 | 3.75 | — |
| 5000 | 10 | 7 | 8.52 | — | 97 | 10.2 | — | 997 | 12.1 | — | 4999 | 20.4 | — |
| 5000 | 50 | 7 | 154 | — | 97 | 161 | — | 997 | 274 | — | 4999 | 353 | — |

TABLE 2
Simulation results for orthogonal matrix generation on HPC Compute Node.

| n | N | p | t | f | p | t | f | p | t | f | p | t | f |
|---|---|---|---|---|---|---|---|---|---|---|---|---|---|
| 5000 | 1 | 7 | 1.40 | 146 | 97 | 1.54 | 10 | 997 | 1.56 | 0 | 4999 | 1.59 | 0 |
| 5000 | 10 | 7 | 4.03 | 148 | 97 | 5.31 | 13 | 997 | 5.37 | 1 | 4999 | 5.91 | 0 |
| 5000 | 50 | 7 | 23.4 | 158 | 97 | 26.5 | 13 | 997 | 26.7 | 1 | 4999 | 27.3 | 0 |
| 10000 | 1 | 7 | 4.85 | 156 | 97 | 5.12 | 7 | 997 | 5.48 | 1 | 4999 | 5.58 | 0 |
| 10000 | 10 | 7 | 15.7 | 153 | 97 | 19.5 | 12 | 997 | 22.1 | 2 | 4999 | 24.7 | 0 |
| 10000 | 50 | 7 | 79.6 | 122 | 97 | 87.1 | 9 | 997 | 94.5 | 1 | 4999 | 101 | 0 |
| 15000 | 1 | 7 | 11.3 | 170 | 97 | 11.5 | 13 | 997 | 12.3 | 0 | 4999 | 12.6 | 0 |
| 15000 | 10 | 7 | 35.2 | 155 | 97 | 43.2 | 11 | 997 | 48.9 | 0 | 4999 | 49.6 | 0 |
| 15000 | 50 | 7 | — | — | 97 | — | — | 997 | — | — | 4999 | — | — |

They present the computational time (t in seconds) required to construct an n×n orthogonal matrix W₀ or an n(N+1)×n(N+1) circulant orthogonal matrix W (see Eq. (6)) with elements from Zₚ by the proposed method. The corresponding columns of the tables display the values of p, n, N, and t. (The gaps in the last row of Table 2 indicate that the available RAM was not sufficient to perform the corresponding computations.) Also, the probabilities of failure for the construction of the corresponding matrices were statistically estimated. Namely, for each triple (p, n, N) 1000 random trials were conducted and the number of failures f recorded. The observed stability of results, as shown in the f column of the table, indicates that the probability of failure is contingent solely upon p. At first glance, this appears particularly surprising, warranting further investigation into its underlying cause.

Below are some 7×7 matrices constructed in Z₉₇ when the degree N in random generators is 1. These examples illustrate that the selected coefficients are rather dispersed even for the lowest value of N. Observe that these matrices are symmetric and the additional simulations confirm that all matrices M∈ [symbol] (n, p) constructed by the proposed method are symmetric for N=1. This indicates that additional regularities can be revealed by further careful exploration of the method.

| | | | | | | | | | | | | | | | | | | | | | | | | | | | | |
|---|---|---|---|---|---|---|---|---|---|---|---|---|---|---|---|---|---|---|---|---|---|---|---|---|---|---|---|---|
| | 85 | 95 | 2 | 1 | 53 | 64 | 11 | | | | 37 | 76 | 22 | 96 | 25 | 71 | 73 | | | | 72 | 25 | 82 | 76 | 69 | 29 | 90 | |
| | 95 | 38 | 60 | 30 | 38 | 77 | 39 | | | | 76 | 86 | 68 | 41 | 42 | 96 | 14 | | | | 25 | 18 | 48 | 9 | 12 | 43 | 3 | |
| | 2 | 60 | 38 | 67 | 59 | 20 | 58 | | | | 22 | 68 | 36 | 91 | 53 | 38 | 50 | | | | 82 | 48 | 11 | 14 | 51 | 13 | 37 | |
| {open oversize bracket} | 1 | 30 | 67 | 83 | 78 | 10 | 29 | {close oversize bracket} | , | {open oversize bracket} | 96 | 41 | 91 | 63 | 2 | 60 | 33 | {close oversize bracket} | , | {open oversize bracket} | 76 | 9 | 14 | 40 | 52 | 57 | 13 | {close oversize bracket} |
| | 53 | 38 | 59 | 78 | 61 | 45 | 82 | | | | 25 | 42 | 53 | 2 | 48 | 52 | 48 | | | | 69 | 12 | 51 | 52 | 38 | 76 | 82 | |
| | 64 | 77 | 20 | 10 | 45 | 59 | 13 | | | | 71 | 96 | 38 | 60 | 52 | 9 | 82 | | | | 29 | 43 | 13 | 57 | 76 | 47 | 19 | |
| | 11 | 39 | 58 | 29 | 82 | 13 | 29 | | | | 73 | 14 | 50 | 33 | 48 | 82 | 17 | | | | 90 | 3 | 37 | 13 | 82 | 19 | 70 | |

The results suggest that the proposed method enables the selection of an orthogonal matrix that meets specific constraints through a comprehensive or nearly comprehensive screening process. To substantiate this claim, an example is provided using 4×4 matrices in [symbol] , where | [symbol] (4,5)| is known to be 28800. Half of these orthogonal matrices have the determinant 1, while the other half have the determinant −1. Therefore, it is sufficient to construct 14400 matrices if one knows that all of them have equal determinants.

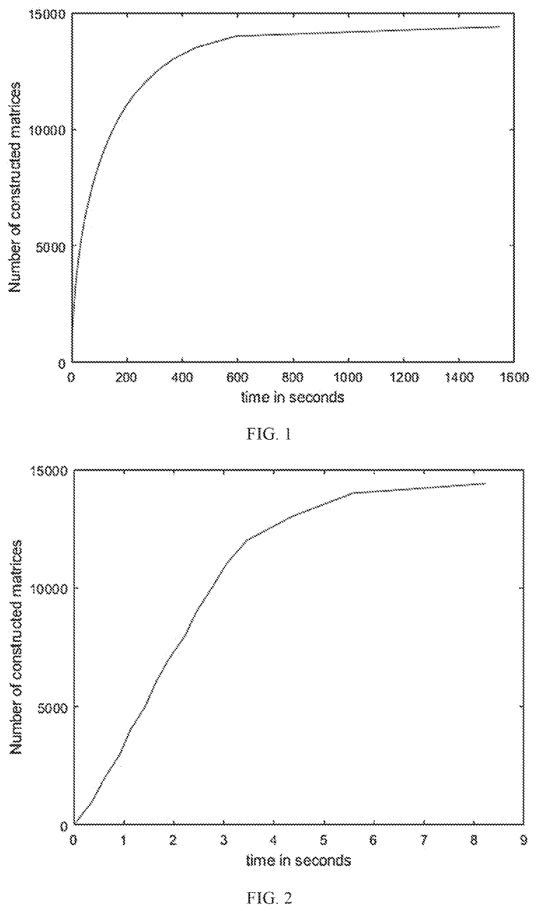

Because of Eq. (22), if N is the number of the coefficients in randomly generated polynomials ζᵢ in Eq. (1), then the determinant of corresponding U(t) is t^{N} for each t from [symbol] . Therefore, det (W)=det (U(−1))=(−1)^{N} and, for any fixed value of N, the method enables the construction of half of the existing orthogonal matrices. For 4×4 matrices, three random polynomials ζ₁, ζ₂, and ζ₃ need to be selected, and there are totally (5³)³=1953125 choices for N=3 coefficients (for each (ζᵢ, i=1, 2, 3,) from [symbol] . A comprehensive screening through all these cases took around an hour (on the laptop) and 14306 different matrices from [symbol] (4,5) were selected. Then a complete screening (on the HPC) through (5⁴)³=244140625 choices for N=4 was initiated, and the process terminated resulting in the selection of all 14400 different matrices in 5354 sec≈1:5 h. Next, all (14400) different matrices from [symbol] (4,5) were constructed by randomly selecting generators ζ₁, ζ₂, ζ₃ with N=4 coefficients from (5⁴)³=244140625 choices. This random process took 1545 sec≈0:43 h and the rate of building these matrices is displayed in FIG. 1, indicating that the majority of matrices were constructed in a relatively short period of time. It has been found that a more efficient strategy was to add all of the left and right even permutations of each newly selected random matrix to the set of already constructed orthogonal matrices. Using this strategy, all 14400 orthogonal matrices (from the same 244140625 options of random choices) were constructed in just 8.22 seconds. The rate of building these matrices is displayed in FIG. 2.

### Conclusion

Described herein is a novel method for generating n×n orthogonal matrices in the Galois field GF(q) that is highly efficient and can handle large values of n and q. This method is based on random selection, but it has been shown that it has a low probability of failure for large q, as verified through statistical testing. In addition, this method can be used to construct paraunitary filter banks over finite fields. This approach can be useful constructing orthogonal matrices that satisfy specific constraints, making it potentially valuable for applications in coding theory, e.g., in constructing linear codes with given hull dimension and minimum distance.

### Definitions

No claim element herein is to be construed under the provisions of 35 U.S.C. § 112 (f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Any references herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

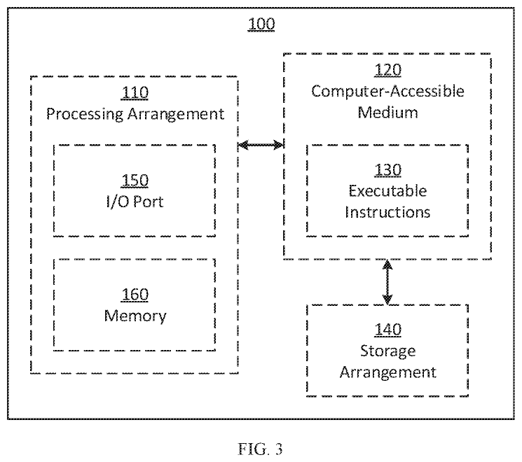

As shown in FIG. 3, e.g., a computer-accessible medium 120 (e.g., as described herein, storage members directly or indirectly to one another. Such joining may be stationary (e.g., permanent) or moveable (e.g., removable or releasable). Such joining may be achieved with the two members or the two members and any device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example. The instructions may include a plurality of sets of instructions.

System 100 may also include a display or output device, an input device such as a keyboard, mouse, touch screen or other input device, and may be connected to additional systems via a logical network. Many of the embodiments described herein may be practiced in a networked environment using logical connections to one or more remote computers having processors. Logical connections may include a local area network (“LAN”) and a wide area network (“WAN”) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Although the figures and description may illustrate a specific order of method steps, the order of such steps may differ from what is depicted and described, unless specified differently above. Also, two or more steps may be performed concurrently or with partial concurrence, unless specified differently above.

1. A method of cryptography comprising:
constructing an orthogonal matrix with elements from finite fields; and
encoding information using the constructed orthogonal matrix.

2. The method of claim 1, wherein constructing the orthogonal matrix comprises generating n×n orthogonal matrices.

3. The method of claim 2, wherein the orthogonal matrix takes the form of
$$G ( t ) = ( \begin{matrix}1 & 0 & 0 & … & 0 & 0 \\ 0 & 1 & 0 & … & 0 & 0 \\ 0 & 0 & 1 & … & 0 & 0 \\ ⋮ & ⋮ & ⋮ & ⋮ & ⋮ & ⋮ \\ 0 & 0 & 0 & … & 1 & 0 \\ {ζ}_{1} ( t ) & {ζ}_{2} ( t ) & {ζ}_{3} ( t ) & … & {ζ}_{n - 1} ( t ) & 1\end{matrix} ) ,$$
where
$${ζ}_{i} ( t ) = {\sum }_{k = 1}^{N} {γ}_{ik} {t}^{- k} ,$$
i=1, 2, . . . , n−1 are Laurent polynomials, further wherein the matrix is generated using positive integers only.

4. The method of claim 1, wherein no matrix inversion occurs during construction of the orthogonal matrix.

5. The method of claim 1, further comprising transmitting a digital file including the encoded information.

6. The method of claim 1, wherein the finite field is Galois field GF(q).

7. The method of claim 1, wherein the constructed orthogonal matrix is a linear code.

8. A method of signal processing comprising:
constructing an orthogonal matrix with elements from finite fields; and
processing a signal with the orthogonal matrix.

9. The method of claim 8, further comprising constructing a discrete wavelet matrix with the elements from the orthogonal matrix.

10. The method of claim 8, wherein the constructed orthogonal matrix is random.

11-14. (canceled)

15. A computer-implemented cryptography system comprising:
one or more processors;
a computer-readable, non-transitory storage medium comprising instructions that, when executed by the one or more processors, cause the one or more processors to:
select, from a finite field having a predetermined number of elements, random coefficients for a plurality of polynomials;
construct, based on the selected coefficients, a paraunitary polynomial matrix over the finite field by executing a modified Janashia-Lagvilava computational procedure that avoids inversion of an m×m matrix; and
convert the paraunitary polynomial matrix into at least one orthogonal matrix over the finite field; and
an encoder configured to apply the orthogonal matrix to input data so as to encrypt data generating encrypted output data, wherein the at least one orthogonal matrix satisfies Q*Q^{T}=I over the finite field;
wherein the the one or more processors is further configured to perform, prior applying the orthogonal matrix, a selection of the orthogonal matrix from a plurality of candidate orthogonal matrices, including the at least one orthogonal matrix, generated according to one or more predetermined constraints.

16. The computer-implemented cryptography system of claim 15, wherein the finite field is a Galois field GF(p^{k}), where p is a prime number and k is a positive integer.

17. The computer-implemented cryptography system of claim 15, wherein the paraunitary polynomial matrix is generated using random Laurent polynomials having coefficients in the finite field and having a degree less than or equal to a predetermined integer N.

18. The computer-implemented cryptography system of claim 15, wherein converting the paraunitary polynomial matrix into the orthogonal matrix comprises generating a block circulant orthogonal matrix having a first block row defined from the paraunitary polynomial matrix coefficients.

19. The computer-implemented cryptography system of claim 15, wherein the predetermined constraints comprise one or more of: a specified determinant value, a specified hull dimension of a corresponding linear code, a specified minimum distance, or a specified matrix symmetry property.

20. The computer-implemented cryptography system of claim 15, wherein the encryption is implemented in a cryptocurrency transaction protocol or secure communication channel using the orthogonal matrix as an encoding key.
